(19) United States
(12) Patent Application Publication
(10) Pub. No.: US 2022/0382614 A1
(43) Pub. Date: Dec. 1, 2022

(54) HIERARCHICAL NEURAL NETWORK-BASED ROOT CAUSE ANALYSIS FOR DISTRIBUTED COMPUTING SYSTEMS

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Yuncong Chen, Plainsboro, NJ (US)

(21) Appl. No.: 17/745,134

(22) Filed: May 16, 2022

Related U.S. Application Data
(60) Provisional application No. 63/193,190, filed on May 26, 2021.

(51) Int. Cl. G06F 11/07; G06F 11/34

(52) U.S. Cl. CPC G06F 11/079; G06F 11/0721; G06F 11/3495

(57) ABSTRACT

Methods and systems for detecting and responding to an anomaly include determining a first system-level performance prediction using system-level statistics. A second system-level performance prediction is determined using system-level statistics and service-level statistics. The first prediction to the second prediction are compared to identify a discrepancy. It is determined that a service corresponding to the service-level statistics is a cause of a detected failure in a distributed computing system. An action directed to the service is performed responsive to the detected failure.

### RELATED APPLICATION INFORMATION

This application claims priority to U.S. patent application Ser. No. 63/193,190, filed on May 26, 2021, incorporated herein by reference in its entirety.

### BACKGROUND

### Technical Field

The present invention relates to distributed computing and, more particularly, to identifying the root cause of a failure in a distributed computing system.

### Description of the Related Art

Microservices are independently deployable services with an automated deployment mechanism, where each in a larger system can be independently updated, replaced, and scaled. Due to the number and complexity of dependency relationships in microservice system components, manually identifying the root cause of a failure in a microservice can be time-consuming, labor-intensive, and error-prone.

### SUMMARY

A method of detecting and responding to an anomaly includes determining a first system-level performance prediction using system-level statistics. A second system-level performance prediction is determined using system-level statistics and service-level statistics. The first prediction to the second prediction are compared to identify a discrepancy. It is determined that a service corresponding to the service-level statistics is a cause of a detected failure in a distributed computing system. An action directed to the service is performed responsive to the detected failure.

A system for detecting and responding to an anomaly includes a hardware processor and a memory that stores a computer program. When executed by the hardware processor, the computer program causes the hardware processor to determine a first system-level performance prediction using system-level statistics, to determine a second system-level performance prediction using system-level statistics and service-level statistics, to compare the first prediction to the second prediction to identify a discrepancy, to determine that a service corresponding to the service-level statistics is a cause of a detected failure in a distributed computing system, and to respond to the detected failure with an action directed to the service.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a distributed computing system with automated failure detection and management, in accordance with an embodiment of the present invention;

FIG. 2 is a block diagram of a processing node in a distributed computing system, in accordance with an embodiment of the present invention;

FIG. 3 is a block/flow diagram of a method for detecting and responding to failures in a distributed computing system, in accordance with an embodiment of the present invention;

FIG. 4 is a block/flow diagram of a method of analyzing operational statistics of a distributed computing system to identify the likely root cause of a failure, in accordance with an embodiment of the present invention;

FIG. 5 is a block diagram of a computing device that may be used to perform root cause analysis and system management in a distributed computing system, in accordance with an embodiment of the present invention;

FIG. 6 is a diagram of an exemplary neural network architecture that may be used to implement a model for detection of failures within a distributed computing system, in accordance with an embodiment of the present invention; and

FIG. 7 is a diagram of an exemplary neural network architecture that may be used to implement a model for detection of failures within a distributed computing system, in accordance with an embodiment of the present invention.

### DETAILED DESCRIPTION OF PREFERRED EMBODIMENTS

Runtime statistics can be collected from microservices and processing nodes in a distributed computing system to help localize the root cause of a failure. For example, the top-k pods and/or nodes may be identified in order of their likelihood to be the root cause of the failure.

For example, a hierarchical attentional deep neural network may be used to process statistics relating to system performance of the whole distributed system, such as latency, connection time, and idle time, and statistics relating to the containers, processing nodes, and pods, such as processor utilization, memory utilization, and disk input/output utilization. This information may be collected before and after the failure event occurs, and may be used to characterize the behavior of the distributed system.

Such failures may occur for any reason, including failures of the physical equipment (e.g., a power failure, a storage failure, cosmic rays, etc.), failures of the virtualized nodes and functions (e.g., configuration errors in a container), and failures of the operating systems or applications running within the virtualized nodes. By identifying the likely source of the fault, which may propagate across multiple different services within the distributed system before causing a noticeable failure, substantial diagnostic time can be saved.

To capture the nonlinear causality effects between system components and failure events, a neural network architecture based on multi-layer perceptrons (MLPs) or long-short term memory (LSTM) layers may be used. Relevant time lags may be selected using a group lasso penalty and a hierarchical group lasso penalty to protect against overfitting. Using the hierarchical structures of the distributed computing system, an attention mechanism may be applied to incorporate causal effects learned from high-level system structure to provide information about low-level causality effects.

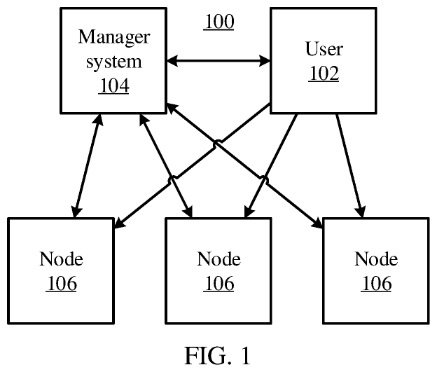

Referring now to FIG. 1, a diagram of a distributed computing system 100 is shown. A user 102 may execute a workload the distribution computing system 100. To this end, the user 102 communicates with manager system 104. The user 102 supplies information regarding the workload, including the number and type of processing nodes 106 that will be needed to execute the workload.

The information provided to the manager system 104 includes, for example, a number of processing nodes 106, a processor type, an operating system, an execution environment, storage capacity, random access memory capacity, network bandwidth, and any other points that may be needed for the workload. The user 102 can furthermore provide images or containers to the manager system 104 for storage in a registry there.

The distributed computing system 100 may include many thousands of processing nodes 106, each of which can be idle or busy in accordance with the workloads being executed by the distributed computing system 100 at any given time. Although a single manager system 104 is shown, there may be multiple such manager systems 104, with multiple registries distributed across the distributed computing system 100.

Before and during execution of the workload, the manager system 104 determines which processing nodes 106 will implement the microservices that make up the corresponding application. The manager system 104 may configure the processing nodes 106, for example based on node and resource availability at the time of provisioning. The microservices may be hosted entirely on separate processing nodes 106, or any number of microservices may be collocated at a same processing node 106. The manager system 104 and the distributed computing system 100 can handle multiple different workloads from multiple different users 102, such that the availability of particular resources will depend on what is happening in the distributed computing system 100 generally.

Provisioning, as the term is used herein, refers to the process by which resources in a distributed computing system 100 are allocated to a user 102 and are prepared for execution. Thus, provisioning includes the determinations made by the manager system 104 as to which processing elements 106 will be used for the workload as well as the transmission of images and any configuration steps that are needed to prepare the processing nodes 106 for execution of the workload.

The manager system 104 collects statistics from the processing nodes 106 and from the microservices running within the processing nodes 106. These statistics characterize the performance of the distributed computing system. In the event of a failure of one of the processing nodes 106 or of a microservice running on one of the processing nodes 106, the manager system 104 can determine the most likely source(s) of the failure. The manager system 104 may refer the failure to a human operator, who can then use the identified source(s) to resolve the failure. In addition, or as an alternative, to review by a human operator, the manager system 104 may automatically take corrective action. For example, the manager system 104 may change an operational state of one or more processing nodes 106 or microservices, change a configuration of one or more processing nodes 106 or microservices, change a security level of one or more processing nodes 106 or microservices, and/or start or stop the distributed computing system. In this way, failures may be automatically resolved, or may be stopped from spreading or causing damage.

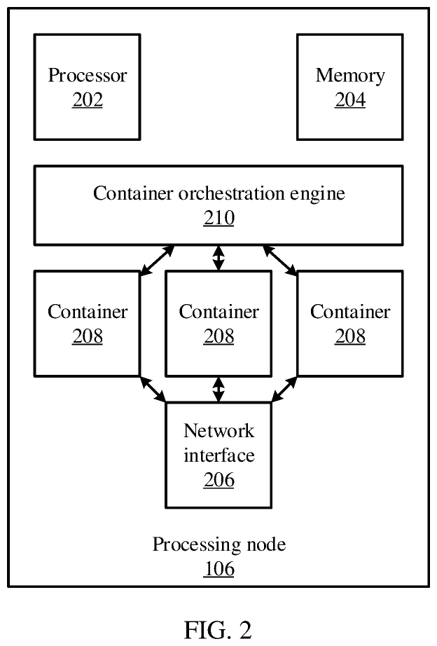

Referring now to FIG. 2, additional detail on a processing node 108 is shown. The processing node 106 includes a hardware processor 202, a memory 204, and a network interface 206. The network interface 206 may be configured to communicate with the manager system 104, with the user 102, and with other processing nodes 106 as needed, using any appropriate communications medium and protocol. The processing node 106 also includes one or more functional modules that may, in some embodiments, be implemented as software that is stored in the memory 204 and that may be executed by the hardware processor 202. In other embodiments, one or more of the functional modules may be implemented as one or more discrete hardware components in the form of, e.g., application-specific integrated chips or field programmable gate arrays.

The processing node 106 may include one or more containers 208. It is specifically contemplated that each container 208 represents a distinct operating environment. The containers 208 each include a set of software applications, configuration files, workload datasets, and any other information or software needed to execute a specific workload. These containers 208 may implement one or more microservices for a distributed application.

The containers 208 are stored in memory 204 and are instantiated and decommissioned by the container orchestration engine 210 as needed. It should be understood that, as a general matter, an operating system of the processing node 106 exists outside the containers 208. Thus, each container 208 interfaces with the same operating system kernel, reducing the overhead needed to execute multiple containers simultaneously. The containers 208 meanwhile may have no communication with one another outside of the determined methods of communication, reducing security concerns.

The containers 208 may be configured to collect statistic information, which is reported back to the manager system 104. The containers 208 may therefore periodically send system-level performance data. The container orchestration engine 210 may mediate the transfer of this information, and may further collect statistics of all containers and applications over a period of time. The manager server 104 receives and analyzes this information.

The microservice data may include data relating to entire processing nodes 106 and data relating to the containers 208 and applications running on the processing nodes 106. Data that relates to the processing nodes 106 may include statistics such as elapsed time, latency, connect time, thread names, throughput, etc. An exemplary format for such data may be: <timeStamp, elapsed, label, responseCode, responseMessage, threadName, dataType, success, failureMessage, bytes, sentBytes, grpThreads, allThreads, URL, Latency, IdleTime, Connect_time>.

The Latency and Connect_time data may be used as key performance indicators (KPIs) of a whole microservice system. Latency measures the time from just before sending a request to the time just after the first piece of a response is received, while Connect_time measures the time it takes to establish a connection, for example including any handshake. Both Latency and Connect_time may be represented as time series data and may indicate system status by reflecting the quality of service. These factors characterize whether the entire system has failure events occurring, because system failure causes an increase to latency and connection times.

Metrics data, meanwhile, may include a number of metrics that indicate the status of a microservice's underlying components. The underlying components can be a microservice's underlying physical machine, container, virtual machine, or pod. The corresponding metrics may include processor utilization or saturation, memory utilization or saturation, or disk input/output utilization. These metrics may also be represented as time series data. An anomalous metric in a microservice's underlying component can be the root cause of an anomalous latency or connection time, which indicates a failure of the microservice.

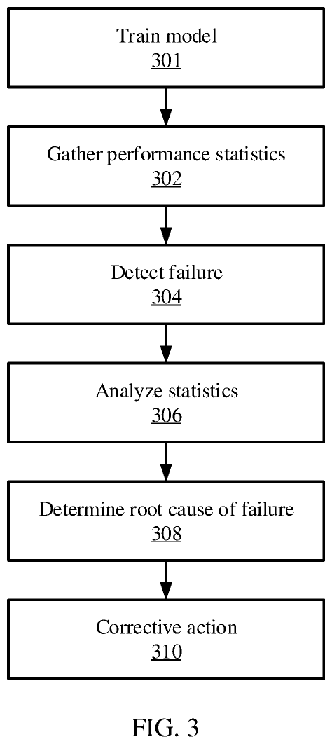

Referring now to FIG. 3, a method of identifying and addressing the root cause of a failure in a distributed computing system is shown. Block 301 trains the model. The model may be implemented using MLP or LSTM architectures. Part of the training of the model may include the selection of a time lag to use in the analysis. A maximum time lag may be used when assessing causality. If the time lag is too short, then causal relationships that occur over longer time periods will be missed. If the time lag is too long, overfitting may occur. If an MLP architecture is used, block 301 may automatically select a time lag that balances these considerations as a trainable parameter. An LSTM architecture may inherently capture time dependencies.

Block 302 gathers performance statistics from the processing nodes 106, the containers 208, and any other appropriate sources in the system. These statistics may be collected on an ongoing basis, and may include time series information that reflects periodic measurements of the relevant indicators.

Block 304 detects a failure in the distributed computing system. Any appropriate failure, anomaly, or fault detection may be employed, and this detection may include identification of system behavior that is outside the norm based on the collected performance statistics and other information. The failure may include a partial failure of the distributed computing system, such as a slowdown or reduction in performance, or may include a total failure of the distributed computing system, such as when the workload of the distributed computing system halts.

Block 306 analyzes the collected statistics, for example using a hierarchical, attentional deep neural network model, as will be described in greater detail below. Block 308 uses this analysis to identify one or more likely sources of the detected failure, which may include a list of processing nodes 106, containers 208, applications, and any other potential root causes of the problem. Block 308 may, for example, output a ranked list of the top-k likely sources.

Block 310 then performs a corrective action to address the fault, responsive to the identified root cause(s). Exemplary corrective actions may include restarting a processing node 106, container 208, microservice, application, or any other appropriate element. Corrective actions may also include changing configurations of the processing node 106, container 208, microservice, or application. In one specific example, where a lack of available bandwidth is identified as a cause of the failure, network settings may be altered to increase bandwidth by allocating a greater portion of the available network bandwidth to a microservice in question, or by changing communication methods used by the microservice to increase its throughput. In another example, for an application or other software that has crashed, a respective container 208 may be restarted to bring the respective microservice back into operational status.

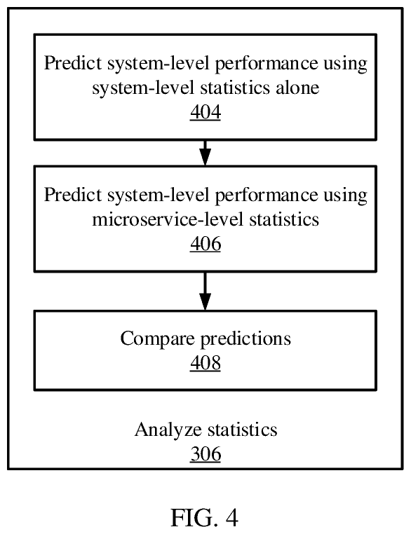

Referring now to FIG. 4, additional detail on the analysis of statistics in block 306 is shown. Block 404 predicts system-level performance using system-level performance statistics alone. For example, using latency and connection time as system-level statistics, failure prediction may be performed using only historical data for these statistics. Block 406 predicts system-level performance using both system-level statistics as well as microservice-level statistics. These two predictions are compared in block 408 to identify differences and to determine whether the addition of the microservice statistics has an effect on the prediction.

A Granger causality test or a vector auto-regressive (VAR) model may be used to test linear causality between time series. However, neural networks are capable of representing complex non-linear interactions between inputs and outputs. Autoregressive MLPs and recurrent neural networks (RNNs) like LSTM networks can be used to forecast multivariate time series data. Thus, deep neural networks can be used to capture the non-linear causality effects between the underlying components and the failure event.

To test whether statistics X have a causal effect on the predicted behavior of statistics Y, two prediction models may be used. The first takes into account a number of historical values of the target time series Y, while the second takes the past values of Y and the time series X. Thus, when block 404 predicts the system-level behavior (Yₜ) using only system-level statistics (Y), this model can be expressed using the nonlinear vector autoregressive:

Model₁:Yₜ=Ψ(Yₜ₋₂,Yₜ₋₂, . . . ,Y_{t-ρ})+ωₜ

When block 406 predicts the system-level behavior using both system-level statistics (Y) and microservice-level statistics (X), the model may be expressed as:

Model₂:Y_{t=Ψ(}Yₜ₋₁,Yₜ₋₂, . . . ,Xₜ₋ₚ,Xₜ₋₁,Xₜ₋₂,. . . X_{t-ρ})+ωₜ

where ρ is a number of prehistorical samples to consider, Ψ is the nonlinear function, and ωₜ is a white noise error term. The training of these models in block 301 may be performed jointly.

The full nonlinear functions Ψ may be modeled using neural networks in a forecasting setting. When Ψ is modeled with MLP, the vector of first layer hidden values at time t may be given by

$${h}_{t}^{1} = σ ( {\sum }_{k = 1}^{ρ} {W}^{1 k} {x}_{t - k} + {b}^{1} )$$

where W¹={W¹¹, . . . , W^{1ρ}} is a weight matrix, b¹ is a bias of the first layer, and ρ is an activation function. Exemplary activation functions may include logistic or tanh functions.

The vector of hidden units in subsequent layers is given by a similar form. After passing through the L-1 hidden layers, the time series output, Yₜ, is given by a linear combination of the units in the final hidden layer:

Yₜ=Ψ(Yₜ₋₁,Yₜ₋₂, . . . ,Xₜ₋ₚ,Xₜ₋₁,Xₜ₋₂, . . . X_{t-ρ})+ωₜ=W^{L}ₕ_{ₜ}^{L-1}+b^{L}+ωₜ

where W^{L} is the linear output decoder and hₜ^{L-1} is the final hidden output from the final L-1^{th} layer. The error term, ωₜ, may be modeled as mean zero Gaussian noise.

RNNs are particularly well suited for modeling time series, as they compress the past of a time series into a hidden state, aiming to capture complicated nonlinear dependencies at longer time lags than traditional time series models. As with MLPs, time series forecasting with RNNs typically proceeds by jointly modeling the entire evolution of the multivariate series using a single recurrent network.

Let hₜ∈R^{H} be the H-dimensional hidden state at time t, representing the historical context of the time series for predicting Yₜ. The hidden state at time t+1 may be updated recursively:

hₜ=f(Yₜ,hₜ₋₁)

where f is some nonlinear function that depends on the particular recurrent architecture.

Due to the effectiveness at modeling complex time dependencies, the recurrent function f may be modeled using an LSTM. The LSTM model introduces a second hidden state variable cₜ, which may be referred to as the cell state, giving the full set of hidden parameter as (cₜ, hₜ).

The differences between the models may be evaluated by comparing a residual sum of squares of their errors. These differences are evaluated by block 308 to determine the root cause of the failure. Block 308 evaluates the null hypothesis, that is that the microservice-level statistics X do not represent the cause of the failure. This determination may be performed using, e.g., the Fisher test. The test may be expressed as:

$$F = ( \frac{( R S {S}_{1} - R S {S}_{2} )}{( {d}_{2} - {d}_{1} )} ) ( \frac{R S {S}_{2}}{n - {d}_{2}} )$$

where RSS₁ and RSS₂ are residual sum of squares relating to Model₁ and Model₂, respectively, n is the size of the lagged variables, and d₁ and d₂ are the number of parameters of Model₁ and Model₂, respectively, and depend structure of the neural networks. Lagged variables may include the lagged values Xₜ₋ᵢ of microservice-level statistics X and lagged values yₜ₋ᵢ of system-level statistics yₜ. Each F value may have a corresponding p-value. Based on the p-value, it can be determined whether two series have a causal relationship. The RSS values may be calculated as:

$$R S S = {\sum }_{i - 1}^{n} {( {\hat{Y}}_{i} - {Y}_{i} )}^{2}$$

where ŷᵢ is i^{th} value of the variable to be predicted, is the predicted value of and n is the total number of time points to be predicted.

A lower p-value (significance of the deviation from a null hypothesis) of the Fisher test indicates a higher likelihood that X is causative of Y. The p-value may be calculated using the sampling distribution of the Fisher test statistic under the null hypothesis. The causal effect score C may therefore be defined as C=1-p. A higher causal effect score indicates a higher likelihood that X is the root cause of Y. The weights of the network may be optimized using stochastic gradient descent (SGD), and an Adam optimization may be used to update the learning rate.

Complex microservice systems may have inherently hierarchical structures. For example, a microservice system may include a number of physical machines, virtual nodes, and containers, each of which may include a number of namespaces and functions. A namespace may include a number of pods/applications. The high-level system components may have hierarchical effects on the low-level components. For example, a system failure of a physical machine may be caused by some running pods on that machine. Thus, the learned high-level causal effects of the system components can help to better identify the low-level root causes. The use of causal effects from the system-level statistics may thus be used to determine microservice-level root causes. The learned system-level causal effect scores may be used as weights or attentions α to guide the low-level root cause identification. For example, the final causal effect score of a microservice A may be expressed as:

Cₐ_{_{final}}C_{node}·C_{A}

where C_{A} is the causal effect score learned at the microservice level and C_{node} is the causal effect score learned from the node that A belongs to.

As to the automatic lag selection that may be performed when MLP models are used, lag selection penalties may be used to detect the time lags at which causal effects are likely to be found. Such penalties may include, e.g., a group lasso penalty and a hierarchical group lasso penalty. The use of MLPs as the deep neural network model is addressed specifically, but it should be understood that the present principles apply to other types of models, such as LSTMs.

Given neural network weights W at each layer, W={W¹, W², . . . , W^{L}}, where L is the number of layers in the neural network. The decomposition of the weights at the first layer across time lags may be expressed as W¹={W¹¹, W¹², . . . W^{1ρ}}. A group penalty may then be applied to the columns of W¹ for each Ψ:

$${min}_{W} {\sum }_{t = ρ}^{T} ( {Y}_{t} - {Ψ ( {X}_{( t - 1 ) : ( t - ρ )} )}^{2} + λ {\sum }_{j = 1}^{m} Υ ( {W}_{: j}^{1} ) )$$

where ρ is the time lag, which may be represented as a number of historical data points, Y is a penalty that shrinks the entire set of first layer weights for input series j (e.g., Wⱼ¹=(W_{:j}¹¹, W_{:j}¹², . . . , W_{:j}^{1ρ})) to zero, λ>0 controls the level of group sparsity, and X_{(t-1):(t-p)} denotes the past ρ values of X. In some cases, no time lag may be specified, in which case all historical data points may be used.

For the group lasso penalty, only some of the lags of a series Xⱼ are assumed to be predictive of series Y and provide both sparsity across groups and sparsity within groups:

$$Υ ( {W}_{: j}^{1} ) = β {‖ {W}_{: j}^{1} ‖}_{F} + ( 1 - β ) {\sum }_{i = 1}^{ρ} {‖ {W}_{: j}^{1 i} ‖}_{2}$$

where ∥·∥_{F} is the Frobenius matrix norm and β∈(0,1) controls the tradeoff in sparsity across and within groups. The group lasso penalty equation can be replaced with the hierarchical group lasso penalty in optimizing an MLP:

$$Υ ( {W}_{: j}^{1} ) = {\sum }_{i = 1}^{ρ} {‖ {W}_{: j}^{11} , … , {W}_{: j}^{1 i} , … , {W}_{: j}^{1 ρ} ‖}_{2}$$

The hierarchical penalty leads to solutions where, for each j, there exists a lag i such that all W_{:j}^{1i′}=0 for i′>i and all W¹ⁱ^{^{:j}}≈0. Thus, this hierarchical penalty effectively selects the lag of each interaction.

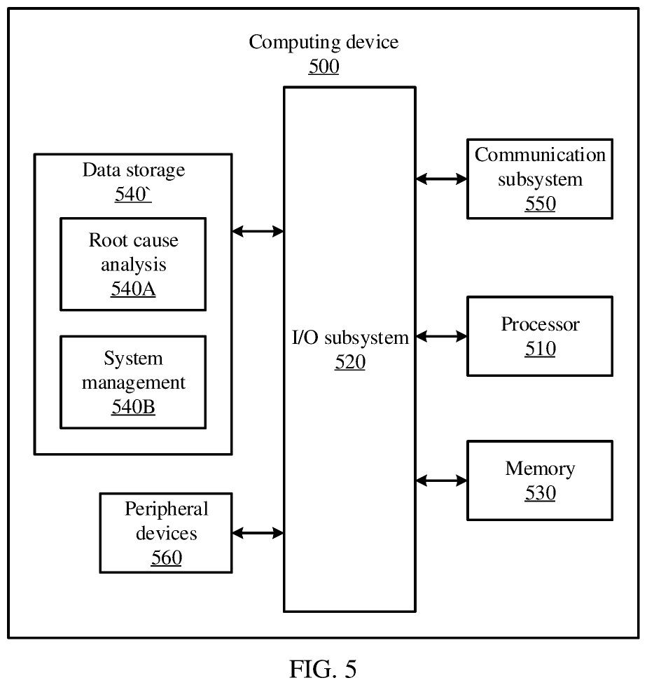

Referring now to FIG. 5, an exemplary computing device 500 is shown, in accordance with an embodiment of the present invention. The computing device 500 is configured to perform classifier enhancement.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor- based system, and/or a consumer electronic device. Additionally or alternatively, the computing device 500 may be embodied as a one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for performing root cause analysis for failures in a distributed computing system and 540B for managing a response to failures within the distributed computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

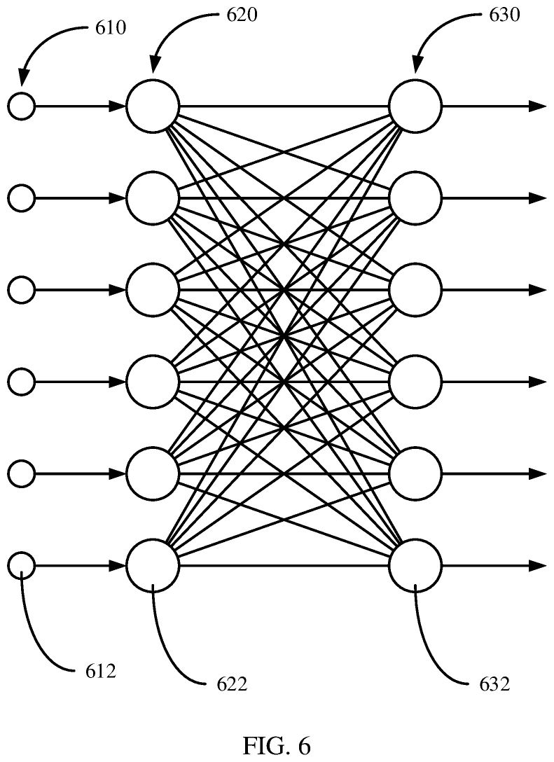

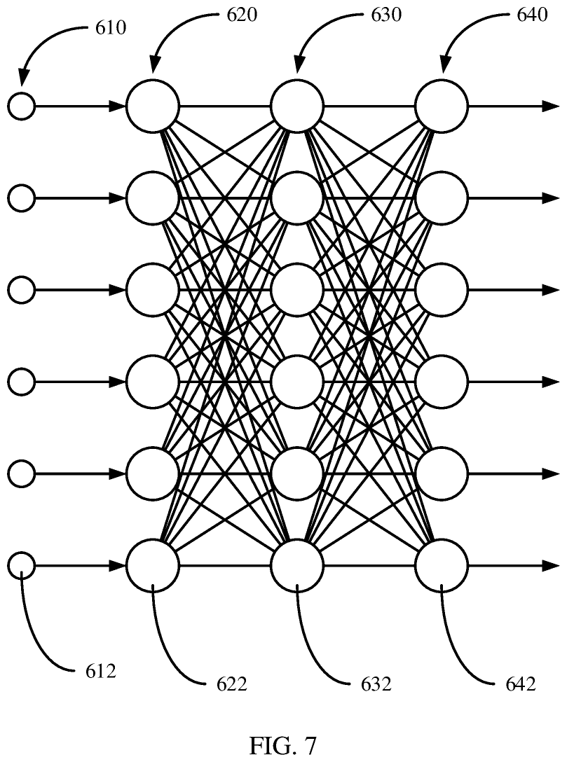

Referring now to FIGS. 6 and 7, exemplary neural network architectures are shown, which may be used to implement parts of the present models. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for detecting and responding to an anomaly, comprising:
determining a first system-level performance prediction using system-level statistics;
determining a second system-level performance prediction using system-level statistics and service-level statistics;
comparing the first prediction to the second prediction to identify a discrepancy;
determining that a service corresponding to the service-level statistics is a cause of a detected failure in a distributed computing system; and
responding to the detected failure with an action directed to the service.

2. The method of claim 1, further comprising generating a list of services, including the service corresponding to the service-level statistics, that is ranked according to a likelihood that the services is a cause of the detected failure.

3. The method of claim 1, wherein determining the first system-level performance prediction is performed using a first model that takes only the system-level statistics as inputs and determining the second system-level performance prediction is performed using a second model that takes the system-level statistics and the service-level statistics as inputs.

4. The method of claim 3, wherein the first model and the second model are implemented using respective deep multilayer perceptron models.

5. The method of claim 4, wherein time lag is a trainable parameter of the deep multilayer perceptron models.

6. The method of claim 5, wherein a hierarchical group lasso penalty is used to train the deep multilayer perceptron models as a lag selection penalty.

7. The method of claim 3, wherein the first model and the second model are implemented using respective long-short term memory (LSTM) models.

8. The method of claim 1, wherein the system-level statistics include latency and connection time.

9. The method of claim 1, wherein comparing the first prediction to the second prediction includes performing a Fisher test.

10. The method of claim 1, wherein responding to the detected failure includes changing an operational state, configuration, or security level of the service or of a node running the service.

11. A system for detecting and responding to an anomaly, comprising:
a hardware processor; and
a memory that stores a computer program which, when executed by the hardware processor, causes the hardware processor to:
determine a first system-level performance prediction using system-level statistics;
determine a second system-level performance prediction using system-level statistics and service-level statistics;
compare the first prediction to the second prediction to identify a discrepancy;
determine that a service corresponding to the service-level statistics is a cause of a detected failure in a distributed computing system; and
respond to the detected failure with an action directed to the service.

12. The system of claim 11, wherein the computer program further causes the hardware processor to generate a list of services, including the service corresponding to the service-level statistics, that is ranked according to a likelihood that the services is a cause of the detected failure.

13. The system of claim 11, wherein the determination of the first system-level performance prediction is performed using a first model that takes only the system-level statistics as inputs and the determination of the second system-level performance prediction is performed using a second model that takes the system-level statistics and the service-level statistics as inputs.

14. The system of claim 13, wherein the first model and the second model are implemented using respective deep multilayer perceptron models.

15. The system of claim 14, wherein time lag is a trainable parameter of the deep multilayer perceptron models.

16. The system of claim 15, wherein a hierarchical group lasso penalty is used to train the deep multilayer perceptron models as a lag selection penalty.

17. The system of claim 13, wherein the first model and the second model are implemented using respective long-short term memory (LSTM) models.

18. The system of claim 11, wherein the system-level statistics include latency and connection time.

19. The system of claim 11, wherein the computer program further causes the hardware processor to compare the first prediction to the second prediction using performing a Fisher test.

20. The system of claim 11, wherein the computer program further causes the hardware processor to respond to the detected failure with a change to an operational state, configuration, or security level of the service or of a node running the service.
